(19) United States
(12) Patent Application Publication
(10) Pub. No.: US 2004/0067696 A1
(43) Pub. Date: Apr. 8, 2004

(54) Electrical wire joiner

(76) Inventor: Michael Llewellyn Vos, Capetown (ZA)

Correspondence Address: John P. Noran, Esquire, SWIDLER BERLIN SHEREFF FRIEDMAN, LLP, 3000 K STREET, SUITE 300, WASHINGTON, DC, 20007, US

(21) Appl. No.: 10/255,491

(22) Filed: Sep. 26, 2002

(51) Int. Cl. H01R 11/03

(52) U.S. Cl. 439/792

(57) ABSTRACT

An easy to use electrical wire joiner comprising two parts which when screwed together with the aid of threaded walls leaving a connection chamber therein for the purpose of twisting and compressing the wires requiring connection.

### BACKGROUND AND BRIEF DESCRIPTION OF THE INVENTION

There are many cases where an easy to use electrical wire joiner may be used.

For instance, where wires leading to a loudspeaker have broken and said wires have to be reconnected.

The object of the invention is to provide a simple and inexpensive way to reconnect these wires and exposed wires in similar situations.

According to the invention an easy to use electrical wire joiner comprises two non-conductive parts with a male and female thread on corresponding ends and when twisted together leaving a connection chamber in the center and two linear holes bored from opposite ends of the joined parts in alignment before the threaded ports are fully tightened. The said linear holes being offset thereby causing the bare wires inserted from both ends to be twisted and flattened in the cavity.

### DESCRIPTION OF THE DRAWINGS

FIG. 1. is a split view of the wire joiner depicting the wires bypassing one another and ready for twisting shut.

FIG. 2. is a split view of the wire joiner depicting the wires having been twisted and compressed.

FIG. 3. is a graphically modeled depiction of the joiner ready to be used but without wires inserted.

FIG. 4. is a modeled graphic with one side exposed by splitting showing the nature of the cavities and their relationship prior to twisting and compressing the wires.

### A DETAILED DESCRIPTION OF THE INVENTION

Referring to the drawings the electrical wire joiner (1) incorporating the invention includes two molded non conductive polymeric parts (2) and (3) which are molded separately with a male thread (11) on one part and a female thread (12) on the second part and then screwed together forming a single entity FIG. 3.

These two part each have a conical shaped receptacle (13) into which the wires to be joined must be inserted.

These conical shaped receptacles continue into a smaller bored linear receptacle (9) and a further receptacle (9) on the corresponding part. The first receptacle at the base of the conical shaped cavity acts as a stopper for the insulating material covering the wire to be joined.

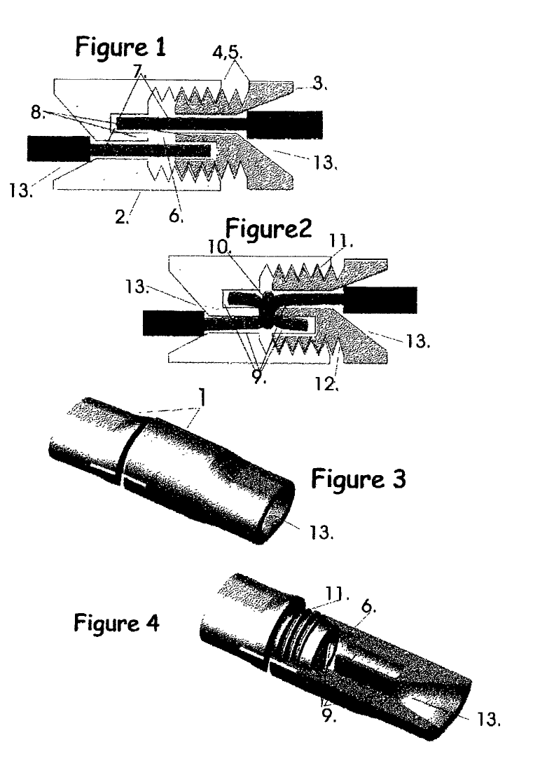

Before the electrical wire joiner is put to use the two parts must be aligned in order that the wires can be inserted through the first part and into the receptacle of the second part (1) & FIG. 1. and therefore the other wire will naturally be inserted through the other part and into the receptacle of the aforesaid first part.

The two parts of the unit are not twisted fully together (4),(5) leaving a cavity (6) between the two parts.

When the wires are inserted (7) they are separated by the plastic (8) between the two bored linear receptacles in which the wires are inserted (9) This causes the wires to be twisted (10) and compressed (10) in the cavity when the two parts are turned fully shut.

What is claimed:

1. An easy to use electrical wire joiner comprising two non-conductive male and female threaded parts which, when screwed together but not to closure leaves a connection chamber in the center and an-off set pair of linear cavities bored through the first part but not fully through the second part in opposing fashion which align before the parts are fully tightened thereby allowing the wires to by-pass each other and causing the wires to be twisted and clamped in the chamber when the two parts are tightened to closure.

2. An easy to use electrical wire joiner to connect the bared ends of two or more electrical wires comprising:
A non-conductive female part with an offset conical shaped end surface in which to insert the bare wire, and a female thread on the other end of same part.
This other end has a matching bored cavity when lined up with the second part.
A non-conductive male part with an offset conical shaped end surface in which to insert the bare wire, a male thread on the other end of same part.
This other end also has a matching bored cavity when lined up with the first part.
The two parts of the electrical wire joiner, when screwed together and lining up the two opposing linear bored holes before the thread reaches the hilt creates a chamber in the middle of the two parts.
Because the bodies of the two parts separate the wires to be connected while aligning them, the wires become twisted together in the chamber when the two parts are tightened together.
